(19) United States
(12) Patent Application Publication
(10) Pub. No.: US 2025/0020756 A1
(43) Pub. Date: Jan. 16, 2025

(54) RELATIVE POSITIONING

(71) Applicant: Telefonaktiebolaget LM Ericsson (publ), Stockholm (SE)

(72) Inventors: Garry IRVINE, Ottawa (CA); Roland SMITH, Nepean (CA); Edwin IUN, Ottawa (CA)

(21) Appl. No.: 18/713,874

(22) PCT Filed: Nov. 30, 2021
(86) PCT No.: PCT/IB2021/061145

§ 371 Date: May 28, 2024

(51) Int. Cl. G01S 5/02; G01S 5/06

(52) U.S. Cl. CPC G01S 5/0244; G01S 5/0284; G01S 5/06

(57) ABSTRACT

A method and network node for relative positioning measurements of wireless device (WD) locations are disclosed. According to one aspect, a method includes phase-locking a plurality of antenna reference points (ARPs), using a synchronous clock, allowing an accuracy of spatial coordinate estimates to be reduced while increasing their precision. The method includes determining time difference of arrival values based at least in part on applying weights to signals received from antennas of a subset of the plurality of phase-locked ARPs to further increase a precision of the spatial coordinate estimates. The method also includes estimating the spatial coordinates by applying timing error corrections to the time difference of arrival values to increase accuracy of the spatial coordinate estimates while maintaining the precision of the spatial coordinate estimates above the second precision level.

### TECHNICAL FIELD

Wireless communication and in particular, to relative positioning measurements of wireless device (WD) locations.

### BACKGROUND

Various positioning technologies for determining a position of a wireless device (WD) have been employed in wireless communication systems, such as in Fourth Generation (4G) and Fifth Generation (5G) (5G is also referred to as “New Radio”) wireless communication systems specified by the Third Generation Partnership Project (3GPP).

Power based positioning solutions such as the advanced enhanced cell identifier (AECID) offers positioning of user devices through pathloss analysis and fingerprinting that combines limited timing information to approximate distance. While such solutions continue to offer value, their accuracies are not extremely high.

Time-based solutions such as Observed Time Difference of Arrival (OTDoA) have also been used to observe and report WD locations such as for E911 calls. OTDoA solutions are called “time difference of arrival” solutions as they estimate device locations based on differences in arrival times of a primary reference signal as measured by the user equipment. OTDoA solutions relate time-of-arrival differences to time-of-flight of the radio frequency signals to enable position processors to estimate user equipment locations from intersections of hyperbolic curves between pairs of antenna reference points (ARP) representing constant time differences.

TDoA solutions in general are more accurate than power-based solutions. However, significant errors can result from the approximations used as well as other factors. The largest contributor to error is cell site relative time errors (rTE) established using precision time protocols (PTPs) such as Institute of Electrical and Electronic Engineers (IEEE) standard 1588v2 to synchronize transmissions of cell sites. These PTPs enable Fourth Generation (4G)/Fifth Generation (5G) transmissions to operate the network free of interference from nearby cell sites. Such cell site synchronization approaches meet requirements for 4G/5G operation, but can introduce significant timing errors of 10s to 100s of nanoseconds, directly impacting the accuracy of TDoA calculations and subsequent device locations estimates. Other errors include ARP location accuracy, differences in cable runs between the ARP and processing hardware, and filter group delay variations. Estimations of OTDoA timing offsets by the WD are loosely specified and can introduce significant timing errors. Also, environmental factors such as multipath can add significant delays and errors to timing estimates. Thus, while TDoA has improved accuracy over power-based positioning solutions, TDoA has many inherent errors which often lead to significant errors in estimated WD locations.

Ultra-wide band (UWB) technology includes dedicated sensor solutions which remove or minimize many of the errors affecting location accuracy. These solutions are exceptionally accurate: often less than 1 m absolute position with 10 cm of precision. The dedicated sensor solution typically employs IEEE 1588v2 timing trees.

While Third Generation Partnership Project (3GPP) and UWB solutions exist and can provide good absolute positioning accuracy, none are focused on the task of providing ultra-high relative positioning.

There are several problems with current technologies.

First, the highest accuracy solutions are currently not 3GPP based and require a separate network to be deployed for positioning in addition to the network that is deployed for 3GPP communications. This issue increases capital expenditures to procure and deploy two networks, and increases operational expenditures to maintain two networks.

Second, non-3GPP based solutions require specialized fixed and remote radios with proprietary chipsets to generate UWB signals for high accuracy round trip time (RTT) measurements to determine location. Non-3GPP compliant solutions limit customers to the proprietary components for all radios, whereas 3GPP solutions empower customers to a wide selection of commercial off the shelf (COTS) devices.

Third, current technology is focused on absolute accuracy and not relative accuracy, opting to implement the IEEE PTP solution to achieve high precision, but not ultra-high precision measurements. Current technology is not designed to support new 5G applications requiring ultra-high relative accuracy such as controlling indoor drones.

### SUMMARY

Some embodiments advantageously provide a method and network node for relative positioning measurements of wireless device (WD) locations.

Some embodiments provide relative positioning by leveraging common sets of phase-locked transmission reference points (TRPs) and antenna reference points (ARP) to generate ultra-high precision relative positioning measurements of WD locations. Some embodiments may be implemented with commercial off the shelf (COTS) 3GPP compliant 5G phones as the remote terminal, with positioning functions in the network equipment.

Some embodiments may include the following steps:
1. Coarsely phase align all “N” remote digital antenna reference points (Dots) to a common reference (e.g., an internal radio unit (IRU));
2. Phase lock all “N” remote digital antenna reference points (Dots) point to a common clock (IRU);
3. Select a minimum subset “M” from the “N” remote digital antenna reference points (Dots) with good signal quality;
4. Select one of the M as a reference, M_{REF};
5. Calculate the cross-correlation of the reference M_{REF} received WD signal with each of the same received WD signals from the other M-1 antenna reference points to determine the time difference of arrival TDoA[i] of the received WD signals;
6. Add radio interface based monitoring (RIBM) timing corrections RIBM[i] to each of the calculated TDoA[i] measurements; and
7. Estimate the position of the WD using the corrected TDoA[i] measurements.

Some applications of relative positioning include:
1. Making ultra-high precision measurements of the relative position of a single WD in motion;
2. Making ultra-high precision measurements of the relative position of two or more WDs in close proximity to each other;
3. Making ultra-high precision measurements of the relative position of one or more WDs in proximity to known anchor locations; and/or
4. Making ultra-high precision measurements of the relative position of one or more WD in proximity to a predefined ubiety identifier.

Some embodiments enable multiple advanced positioning applications to be realized, including robotic arm and/or manipulator control, coordinated multiple devices tracking such as tracking a swarm of drones, ultra-high accuracy positioning with respect to known anchors which may be located in a service area, and advanced Fifth Generation (5G) location based services with ubiety identifiers.

Some embodiments overcome known impairments or multipath effects and operate in both line of sight (LoS) and non-LoS conditions, including static or dynamically changing path obstructions. This result may be achieved in some embodiments when the ultra-high precision measurement rate is significantly faster than changes in the channel conditions.

In some embodiments, the clock/time stability of the ARP may greatly exceed the clock/time stability of a common time base such as an IRU. Also, some embodiments take advantage of the static nature of most common mode errors that impact ToA estimates. For example, the common mode errors may include Dot coordinate errors, bulk acoustic wave (BAW) and surface acoustic wave (SAW) filter delays, and temperature effects.

The ultra-high precision relative positioning measurements enable control applications where absolute measurements are not needed. This includes relative control of a robot where the starting location is known and only relative motion control is needed.

Ultra-high precision relative positioning measurements with respect to one or more physically installed anchors may also enable high accuracy positioning within a local fixed anchor reference frame.

The relative positioning methods described herein may facilitate mobility training. Ultra-high precision positioning measurements according to these methods may provide high temporal stability, enabling operators to train robotic mobility and repeat the mobility at a later time. For example, robotic parcel delivery may be trained using the relative positioning methods described herein.

Ultra-high precision and time stability provided by the relative positioning methods described herein enable virtual anchors called “ubiety identifiers” to be employed in some embodiments. In these embodiments, positioning may be relative to customer defined “ubiety locations” which are locations important to customers. Customer can use a smart phone application to mark “ubiety locations” in the same or similar way that the customer would deploy BlueTooth beacons at the same locations. The ultra-high precision relative location accuracy providing herein enables WDs to be tracked relative to those marked locations, so that third party applications will know the relative location of smart phone users with respect to the defined ubiety identifiers. The ultra-high relative accuracy therefore enables new customer revenue streams.

Relative positioning can be used with mobility anchor systems, enabling positioning in a changing reference system such as positioning within a moving indoor platform, or positioning along a moving conveyor belt. In these cases, absolute positioning may be less important than relative positioning within the changing reference frame.

Relative positioning can be used to achieve ultra-high relative accuracy in the positioning of drones for indoor applications such as visual theatre displays, advanced advertising, or even food delivery. While demonstration of coordinated drones for outdoor visual light shows are becoming more common, they typically rely on global positioning system (GPS) reference signals, but no such reference signals exist indoors. Some embodiments enable such indoor applications.

Also, ultra-high precision positioning measurements which can discern relative distances of centimeters or even millimeters enable object “orientation” to be measured.

According to one aspect, a method in a network node for estimating spatial coordinates of a WD to achieve a relative positioning accuracy. The method includes phase-locking a plurality of antenna reference points, ARPs, using a synchronous clock, the phase-locking configured to allow an accuracy of spatial coordinate estimates to be reduced from a first accuracy level to a second accuracy level while increasing a precision of the spatial coordinate estimates above a first precision level. The method also includes determining time difference of arrival values based at least in part on applying weights to signals received from antennas of a subset of the plurality of phase-locked ARPs, the weights and phase-locked ARPs in the subset of phase-locked ARPs being determined to increase a precision of the spatial coordinate estimates above a second precision level higher than the first precision level. The method further includes estimating the spatial coordinates by applying timing error corrections to the time difference of arrival values, the applied timing error corrections being determined to increase accuracy of the spatial coordinate estimates above the second accuracy level, while maintaining the precision of the spatial coordinate estimates above the second precision level.

According to this aspect, in some embodiments, the applied timing error corrections are based at least in part on over-the-air timing measurements. In some embodiments, determining the time difference of arrival values includes: selecting one ARP in the subset of the plurality of phase-locked ARPs to be a reference ARP; and correlating a signal from the reference ARP with signals from other ARPs in the subset of the plurality of phase-locked ARPs. In some embodiments, the method includes prior to phase-locking the plurality of ARPs, obtaining a coarse phase alignment of the plurality of ARPs using a precision time protocol, PTP. In some embodiments, the method includes choosing ARPs to be in the subset of the plurality of phase-locked ARPs based at least in part on a level of multipath. In some embodiments, the method also includes choosing ARPs to be in the subset of the plurality of phase-locked ARPs based at least in part on reducing a covariance of the spatial coordinate estimates. In some embodiments, phase-locking the plurality of ARPs further comprises synchronizing the ARPs to a common clock reference to reduce non-common mode errors relative to common mode errors. In some embodiments, a number of phase-locked ARPs to be included in the subset of the plurality of phase-locked ARPs is a minimum number achievable subject to at least one constraint. In some embodiments, the applied timing error corrections are added to the time difference of arrival values. In some embodiments, the spatial coordinate estimates are determined relative to a ubiety location selected by a user of the WD.

According to another aspect, a network node for estimating spatial coordinates of a WD to achieve a relative positioning accuracy is provided. The network node includes a synchronous clock, a plurality of antenna reference points, ARPs; and processing circuitry in communication with the synchronous clock and the plurality of ARPs. The processing circuitry is configured to: phase-lock the plurality of ARPs using the synchronous clock, the phase-locking configured to allow an accuracy of spatial coordinate estimates to be reduced from a first accuracy level to a second accuracy level lower than the first accuracy level while increasing a precision of the spatial coordinate estimates above a first precision level, the ARPs being spatially distributed. The processing circuitry is further configured to determine time difference of arrival values based at least in part on applying weights to signals received from antennas of a subset of the plurality of phase-locked ARPs, the weights and phase-locked ARPs in the subset of the plurality of phase-locked ARPs being determined to increase a precision of the spatial coordinate estimates above a second precision level higher than the first precision level. The processing circuitry is also configured to estimate the spatial coordinates by applying timing error corrections to the time difference of arrival values, the applied timing error corrections being determined to increase accuracy of the spatial coordinate estimates above the second accuracy level, while maintaining the precision of the spatial coordinate estimates above the second precision level.

According to this aspect, in some embodiments, the applied timing error corrections are based at least in part on over-the-air timing measurements. In some embodiments, determining the time difference of arrival values includes: selecting one ARP in the subset of the plurality of phase-locked ARPs to be a reference ARP; and correlating a signal from the reference ARP with signals from other ARPs in the subset of the plurality of phase-locked ARPs. In some embodiments, the processing circuitry is further configured to, prior to phase-locking the plurality of ARPs, obtain a coarse phase alignment of the plurality of ARPs using a precision time protocol, PTP. In some embodiments, the processing circuitry is further configured to choose ARPs to be in the subset of the plurality of phase-locked ARPs based at least in part on a level of multipath. In some embodiments, the processing circuitry is further configured to choose ARPs to be in the subset of the plurality of phase-locked ARPs based at least in part on reducing a covariance of the spatial coordinate estimates. In some embodiments, phase-locking the plurality of ARPs further comprises synchronizing the plurality of ARPs to a common clock reference to reduce non-common mode errors relative to common mode errors. In some embodiments, a number of phase-locked ARPs to be included in the subset of the plurality of phase-locked ARPs is a minimum number achievable subject to at least one constraint. In some embodiments, the applied timing error corrections are added to the time difference of arrival values. In some embodiments, the spatial coordinate estimates are determined relative to a ubiety location selected by a user of the WD.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates various combinations of low and high precision and accuracy;

FIG. 2 illustrates an effect of achieving high precision without attempting to improve accuracy;

FIG. 3 illustrates an effect of achieving ultra-high precision without further decreasing accuracy;

FIG. 4 illustrates an effect increasing accuracy while maintaining ultra-high precision;

FIG. 5 is a flow diagram showing an example of the sequence of steps for achieving high accuracy and ultra-high precision;

FIG. 6 is a block diagram of a communication system that includes a WD location engine to determine relative position of a WD with ultra-high precision according to principles set forth herein;

FIG. 7 is a block diagram of a communication system that includes a WD, a radio base station and a network node configured to determine relative position of a WD with ultra-high precision according to principles set forth herein;

FIG. 8 is a flowchart of an example process in a WD location engine for achieving an ultra-high precision position estimate;

FIG. 9 is a graph of coarse phase lock between two antenna reference points;

FIG. 10 is a plot of rTEs over time for two antenna reference points; and

FIG. 11 is a flowchart of another example process in a WD location engine for determining relative position of a WD for achieving an ultra-high precision position estimate.

### DETAILED DESCRIPTION

Before describing in detail exemplary embodiments, it is noted that the embodiments reside primarily in combinations of apparatus components and processing steps related to relative positioning measurements of wireless device (WD) locations. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof. In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “radio base station” used herein can be any kind base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

The term “network node” used herein may include a WD location engine and a phase-locking unit as described herein. The term “network node” may also encompass a radio base station.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device, radio base station or network node may be distributed over a plurality of wireless devices, radio base stations and/or network nodes. In other words, it is contemplated that the functions of the network nodes, radio base stations and wireless devices described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments include methods and network nodes configured to determine a relative position and optionally, an absolute position (relative to the earth), of a wireless device (WD).

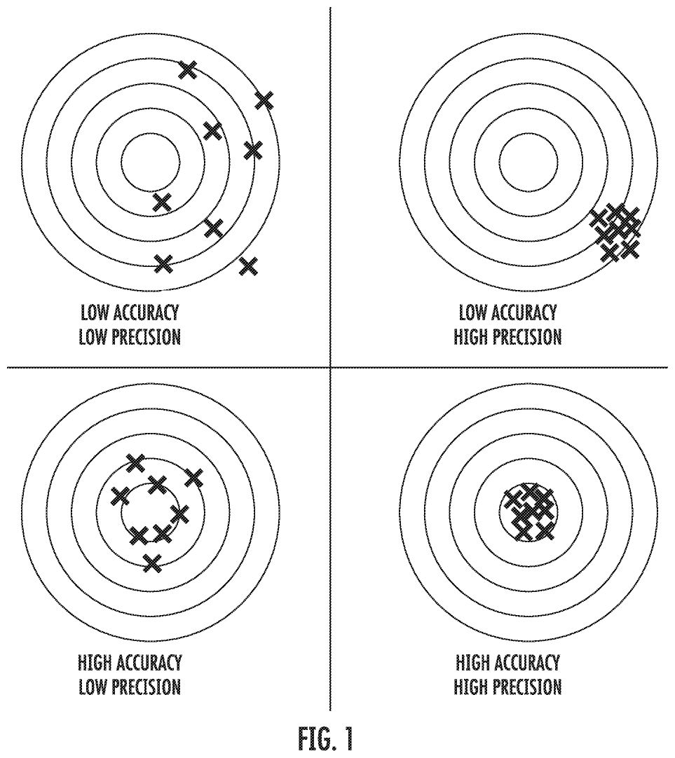

In some embodiments, a relative positioning method makes use of three non-intuitive steps that result in reduced absolute accuracy and improved precision or relative accuracy. To understand this tradeoff, the difference between accuracy as an absolute measurement, and precision as a consistent relative measurement is herein discussed with reference to FIG. 1.

High absolute accuracy calls for a low relative time error (rTE), which in turn calls for phase alignment of the antenna reference point (ARP) of downlink (DL) transmissions for observed time difference of arrival (OTDoA), or uplink (UL) receptions for uplink time difference of arrival (UTDoA). ARP alignment is typically achieved through real-time proportional-integral-derivative (PID) control loops which use precision time protocol (PTP) time stamps to optimally adjust the clocks to minimize absolute phase alignment error. Such systems typically achieve alignment with absolute rTE drifts measured in nanoseconds over extended time periods of hours or days. In this case, time of arrival (ToA) measurements appear as the “High Accuracy, Low Precision” example in FIG. 1.

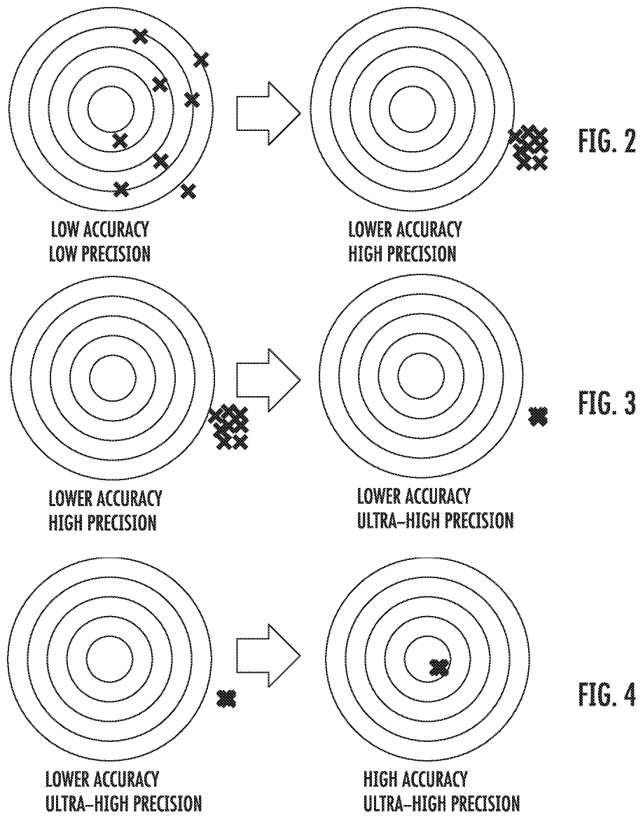

A first non-intuitive step is to reduce absolute phase alignment by using a synchronous clock to phase lock all ARPs. By using a synchronous clock such as a SyncE clock or other high rate clock, clock stability measured in picoseconds can be achieved and used to obtain high precision relative positioning. In some embodiments, 3GPP levels of levels of phase alignment with absolute rTEs of tens of nanoseconds are achieved, but with relative rTE jitter measured in picoseconds with stability that can last for days. The resulting performance is a tightly clustered set of ToA measurements demonstrating high precision, possibly at the expense of decreased accuracy. In this case, ToA measurements appear as the “Low Accuracy, High Precision” example of FIG. 1. This first step may further reduce the solution accuracy from “Low” to “Lower” as shown in FIG. 2. Although FIG. 2 shows the transition from Low Accuracy to Lower Accuracy, this does not necessarily mean the accuracy must degrade. Rather, this may also include embodiments, where the accuracy does not degrade while precision increases.

A second non-intuitive step may be taken to further improve precision without attempting to improve accuracy. In this step, constraints may be placed on the number of ARP measurements included in the positioning calculations and measurement filtering to average the ARP measurements is omitted. Omission of the filtering results in relative positioning that is less accurate, but the time of arrival values may have the same errors. In some embodiments, the filtering may avoid dilution of precision. Optimal estimation techniques such as minimizing mean squared errors of measurement sets may be applied. This second non-intuitive step limits the number of measurements to a minimum subset necessary to achieve a position estimate (typically 3 or 4 ToA measurements), and applies fixed weightings to ARPs, resulting in increased precision of repeated position estimates. This step improves repeated positioning estimates from “High” to “Ultra-High” precision with ToA errors measured in picoseconds for centimeter differences. While this step does not attempt to improve the absolute accuracy, it improves precision or relative accuracy. An example of this is shown in FIG. 3. This second non-intuitive step may include not only fixing ARPs, but also fixing branch data paths and weightings over a time duration so as to minimize variations to common mode errors.

A third step applies corrections to the high precision measurements to substantially restore absolute accuracy, as shown in the example of FIG. 4. These corrections can be derived from one or more sources that may include:
1. RIBM rTE measured offsets. These over-the-air measurements provide high accuracy estimates of rTE between different ARPs;
2. Anchor ToA measurements. These over-the-air measurements provide high accuracy estimates of known anchor locations, which can be used to derive rTE corrections;
3. UE ToA measurements; and/or
4. Macro radio base station (RBS) RIBM measurements.

Application of this third step moves ToA measurements from “Lower Accuracy, Ultra-High Precision” to “High Accuracy, Ultra-High Precision” thereby improving the overall accuracy, while maintaining the ultra-high precision achieved by application of the first and second non-intuitive steps discussed above.

While the third step may not be needed for relative positioning, the third step provides the high accuracy positioning estimates that users prefer.

Thus, some embodiments disclosed herein provide a positioning solution with high absolute accuracy and ultra-high precision or relative accuracy. To achieve this, in some embodiments, there is phase lock synchronization of the antenna reference points to a common clock reference (IRU). Minimized differential errors may be achieved by fixing signal to interference plus noise ratio (SINR) weightings and selecting the same (or a similar) minimized ARP set to estimate relative positions of the WD, which further increases common mode errors.

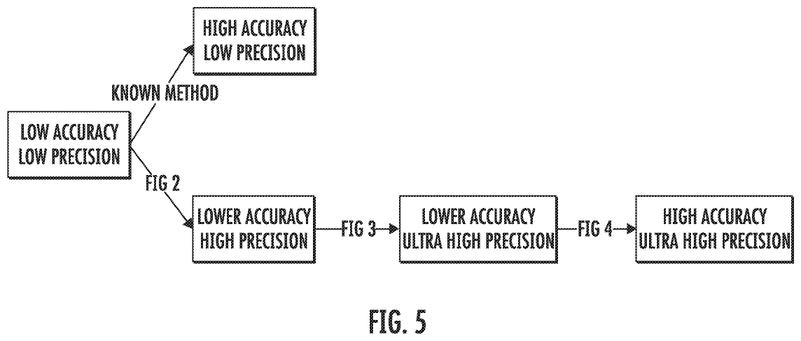

FIG. 5 is a flow diagram showing an example sequence of steps for achieving high accuracy and ultra-high precision as depicted in FIGS. 2-4.

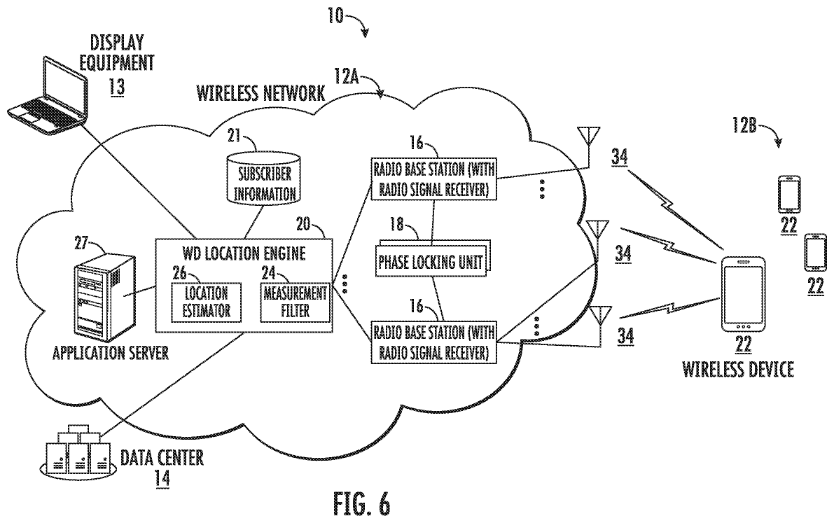

FIG. 6 shows a communication system 10 that includes a wireless network 12A and a wireless device network 12B, collectively referred to as an access network 12. The system of FIG. 6 may also include display equipment 13 and a data center 14. The wireless network 12A may be, for example, a 3GPP 4G and/or 5G network, a Wi-Fi network and/or a proprietary radio network. The wireless network 12A includes radio base stations 16 that are coupled to antennas 34 having respective antenna reference points. The wireless device network 12B includes a plurality of WDs 22 in radio frequency (RF) communication with one or more of the radio base stations 16. The radio base stations 16 may be synchronized by a phase locking unit 18. A WD location engine 20 determines a WD location with high accuracy and with ultra-high precision as compared to accuracy and precision determinations of known methods. A phase locking unit 18 may provide a high precision timing reference to each radio base station 16. The phase locking unit 18 enables synchronization and timing alignment for each ARP of the antennas 34.

The WD location engine 20 is in communication with a subscriber information database 21 and includes a measurement filter 24 and a location estimator 26 to provide ultra-high precision location estimation. The WD location engine 20 may also be in communication with an application server 27, the display equipment 13 and the data center 14. Note that the WD location engine 20 may be located in a separate node or may be located within one or more radio base stations 16.

The radio base stations 16 can be 4G and/or 5G radio base stations and/or radio access points, for example. Each radio base station 16 knows the exact position of the ARPs of antennas 34 from which the radio base station 16 receives signals from the WDs 22.

The WD location engine 20 collects uplink time difference of arrival (UTDoA) measurements from the radio base stations 16. The subscriber information database 21 provides information concerning subscribers that enables the WD location engine 20 to differentiate between WDs 22 whose positions are being measured.

The location estimator 26 resolves the relative location of the WD 22 into an absolute location. This can be done for example, by determining intersections of hyperbolic curves representing possible locations of the WD 22. In the alternative, WD location is determined as an intersection of a plurality of circles having radii based on round trip time. The measurement filter 24 filters out measurements that may not contribute to the accuracy of the calculation of a position of a WD 22. The measurements to be filtered may be selected based on a signal to noise ratio or an extent of multi-path effects. The application server 27 may use the determined absolute location for various purposes including providing a location for an E911emergencies.

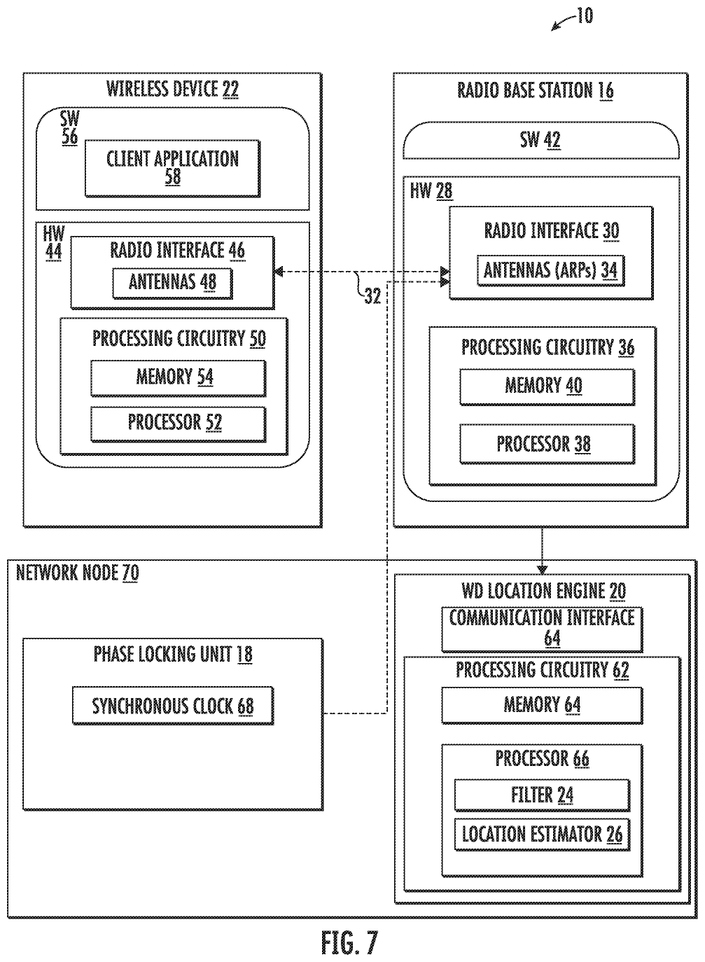

FIG. 7 is a block diagram of communication system 10 that includes a radio base station 16 in communication with a wireless device 22 and further in communication with the WD location engine 20, according to some embodiments of the present disclosure. The radio base station 16 includes hardware 28 enabling communication with the wireless device 22. The hardware 28 may include a radio interface 30 for setting up and maintaining at least a wireless connection 32 with a WD 22 located in a coverage area served by the radio base station 16. The radio interface 30 may be formed as or may include, for example, one or more RF transmitters, one or more RF receivers, and/or one or more RF transceivers. The radio interface 30 may include one or more antennas 34 to radiate and receive signal(s) carrying electromagnetic waves.

In the embodiment shown, the hardware 28 of the radio base station 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the radio base station 16 further has software 42 stored internally in, for example, memory 40, or stored in external memory (e.g., database, storage array, network storage device, etc.) accessible by the radio base station 16 via an external connection. The software 42 may be executable by the processing circuitry 36. The processing circuitry 36 may be configured to control any of the methods and/or processes described herein and/or to cause such methods, and/or processes to be performed, e.g., by radio base station 16. Processor 38 corresponds to one or more processors 38 for performing radio base station 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to radio base station 16.

For example, processing circuitry 36 of the radio base station 16 may be in wireless or wired communication with the WD location engine 20. The WD location engine 20 determine time difference of arrival values based at least in part on applying weights to signals received from antennas 34 of a plurality of radio base stations 16 at a subset of the antenna reference points, and estimate spatial coordinates by applying timing error corrections to the time difference of arrival values.

The WD 22 may have hardware 44 that may include a radio interface 46 configured to set up and maintain a wireless connection 32 with a radio base station 16 serving a coverage area in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22.

The WD location engine 20 includes a communication interface 60, which may be a wired or wireless interface, that receives time of arrival values from a plurality of radio base stations 16. The WD 22 further includes processing circuitry 62. The processing circuitry 62 may include a memory 64 and a processor 66. In particular, in addition to or instead of a processor, such as a central processing unit, and memory, the processing circuitry 62 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 66 may be configured to access (e.g., write to and/or read from) memory 64, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD location engine 20 may further include software which is stored in memory 64, or stored in external memory (e.g., database, storage array, network storage device, etc.) accessible by the WD location engine 20. The software may be executable by the processing circuitry 62.

The processing circuitry 62 may be configured to control any of the methods and/or processes described herein and/or to cause such methods, and/or processes to be performed, e.g., by WD location engine 20. The processor 66 corresponds to one or more processors 66 for performing WD location engine functions described herein. The WD location engine 20 includes the memory 64, which is configured to store data, programmatic software code and/or other information described herein. In some embodiments, the software may include instructions that, when executed by the processor 66 and/or processing circuitry 62, causes the processor 66 and/or processing circuitry 62 to perform the processes described herein with respect to WD location engine 20.

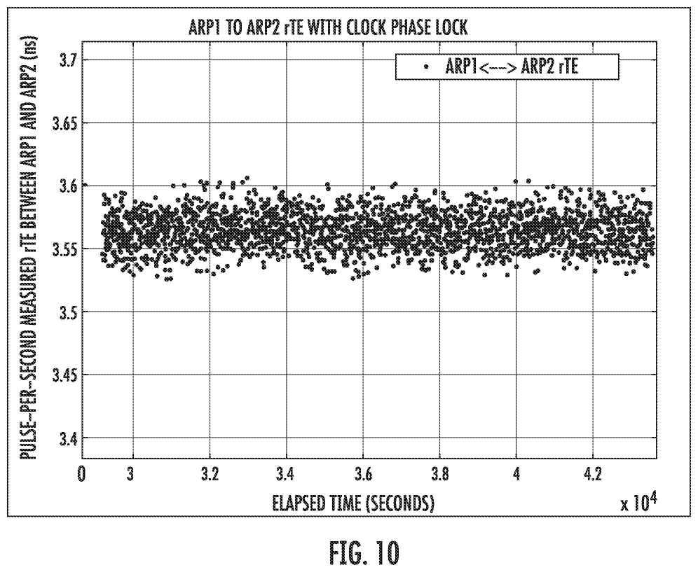

The processor 66 is configured to perform the functions of the measurement filter 24 and the location estimator 26. The measurement filter 24 is configured to filter out measurements that would lead to inaccuracy of the position determination made by the location estimator 26. The location estimator 26 performs a multi-step process such as, for example, the process shown in FIG. 7 and/or FIG. 10.

The communication system 10 also includes the phase locking unit 18 which is configured to provide a timing reference from a synchronous clock 68 for the antenna reference points (ARP) for the antennas 34 of a plurality of radio base stations 16. Note that the WD location engine 20 and/or the phase locking unit 18 may be placed within a radio base station 16, or distributed among a plurality of radio base stations 16. In some embodiments, the phase locking unit 18 may be within the WD location engine 20 which is separate from a radio base station 16. In some embodiments, the WD location engine 20 and the phase locking unit 18 may be considered collectively as a network node 70. In such embodiments, the phase locking unit 18 and the WD location engine 20 may be implemented in the same physical device, i.e., computing device, or may be physically separate devices operating as a single logical network node 70.

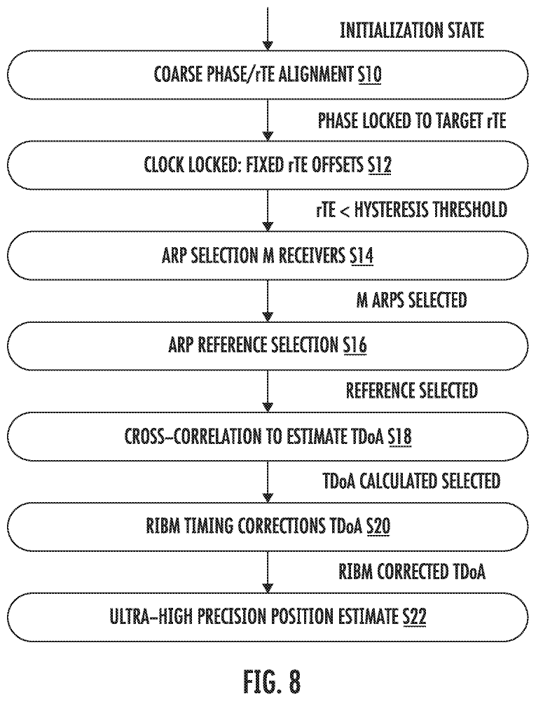

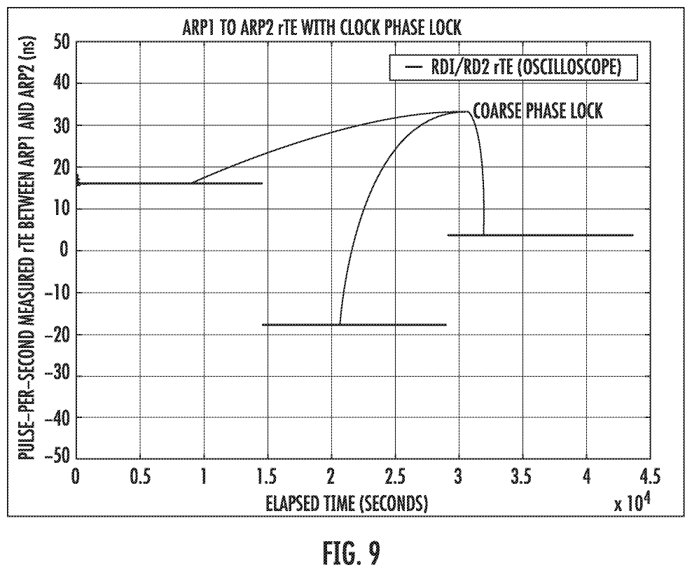

As shown in the flow chart of FIG. 8, the location estimator 26 of the WD location engine 20, in an initialized state, may perform coarse phase/rTE alignment of the relative time error (rTE) between antenna reference points (ARPs) of the antennas 34 (Block S10). This coarse alignment may be achieved using Precision Time Protocol (PTP) to align 1 pulse per second (PPS) clocks which may be generated by a synchronous clock 68. ARP coarse phase alignment is used in 3GPP systems to eliminate inter-symbol interference (ISI), with finer phase lock necessary for multiple input multiple output (MIMO) stream operations. The example graph of FIG. 9 shows phase alignment errors less than ±20 ns which eliminates ISI and ensures correct MIMO operation.

Referring again to FIG. 8, once coarse phase alignment is performed, the WD location engine 20 switches to a Clock Lock with Fixed rTE Offsets step (Block S12) rather than applying further phase alignment using PTP feedback timing packets. Clock locking enables high stability, as shown in the example graph of FIG. 10, with two ARPs as 70 ps p-p or <15 ps RMS. Note that a 15 ps ARP rTE jitter represents a relative over the air (OTA) measurement error of 5 mm, when taken as individual measurements. However, the measurements above may be further time-filtered using a Kalman filter or other filters to significantly reduce measurement variance. An improvement of 80% may be achievable, yielding an OTA precision with relative error less than 1 mm. Thus, in some embodiments, the rTEs are configured to be less than a hysteresis threshold.

The above level of clock timing jitter may not be possible without high-quality timing sources such as those employed in 3GPP radios. It is well known that 3GPP radios are required to meet stringent frequency and timing specifications. 3GPP specifications demand a maximum +50 ppb (parts per billion) frequency error and often 3GPP radios are 3 times better than this specification. The 3GPP timing specifications for 5G specify a ±1200 ns phase error to ensure symbol transmissions do not cross cyclic prefix windows. Often 3GPP radios are at least 4 times better than this specification ensuring that 5G networks do not suffer inter-symbol interference.

Thus. while clock phase locking is employed in some embodiments, achieving high precision relative positioning measurements may call for a high-quality timing reference found in 3GPP radio designs.

Referring again to FIG. 8, a next step in the process may be referred to as ARP Selection of M receivers of a plurality of radio base stations 16 (Block S14). Typically, networks often have very many receivers deployed across a building with many located far away from an assumed location of the WD 22. ARP selection enables a subset of “M” receivers to be employed in the analysis of the ToA measured data. In some embodiments, the subset of M-receivers and the relative weights applied to each of these measurements in the hyperbolic intersection curves should remain constant to achieve ultra-high precision consecutive measurements.

In some embodiments, the process of ARP selection of M receivers may be based on an assumption that the receivers are spatially close to the WD being tracked and generally with good signal levels. Other factors may be applied such as the assessed level of multipath in the received signal. The geometry or relative locations of the M ARP receivers is a factor that may be assessed by the WD location engine 20 to minimize the covariance of the calculated WD relative position estimates. Selection of M receivers may remain effectively constant during the relative positioning estimates to ensure that contributions of the non-common mode errors remains constant from each of the M receiver ARPs.

In step S16, the WD location engine 20 selects a reference receiver, denoted herein as M_{REF}. The signal from the reference receiver is correlated with signals from the other receivers in step S18 to estimate time differences of arrival of signals received from the different receivers of the radio interfaces 30 of the radio base stations 16. Then RIBM timing corrections to the TDoA may be made to reduce absolute timing errors (Block S20). While RIBM is mentioned as a timing correction source, other methods are also possible including calculations involving anchors. A result of the timing corrections is an ultra-high precision position estimate (Block S22).

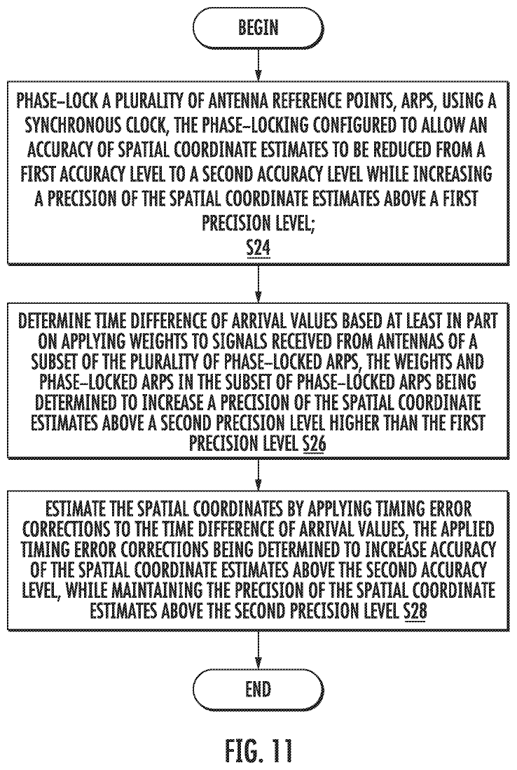

FIG. 11 is a flowchart of an example process in a network node 70 for relative positioning measurements of wireless device (WD) locations. One or more blocks described herein may be performed by one or more elements of network node 70 such as by one or more of processing circuitry 36 (including the location estimator 26), processor 38, and/or radio interface 30. Network node 70 such as via processing circuitry 36 and/or processor 38 and/or radio interface 30 is configured to phase-lock a plurality of antenna reference points, ARPs, using a synchronous clock 68, the phase-locking configured to allow an accuracy of spatial coordinate estimates to be reduced from a first accuracy level to a second accuracy level while increasing a precision of the spatial coordinate estimates above a first precision level (Block S24). The process also includes determining time difference of arrival values based at least in part on applying weights to signals received from antennas of a subset of the plurality of phase-locked ARPs, the weights and phase-locked ARPs in the subset of phase-locked ARPs being determined to increase a precision of the spatial coordinate estimates above a second precision level higher than the first precision level (Block S26). The process further include estimating the spatial coordinates by applying timing error corrections to the time difference of arrival values, the applied timing error corrections being determined to increase accuracy of the spatial coordinate estimates above the second accuracy level, while maintaining the precision of the spatial coordinate estimates above the second precision level (Block S28).

According to one aspect, a method in a network node 70 for estimating spatial coordinates of a WD 22 to achieve a relative positioning accuracy. The method includes phase-locking a plurality of antenna reference points, ARPs, using a synchronous clock 68, the phase-locking configured to allow an accuracy of spatial coordinate estimates to be reduced from a first accuracy level to a second accuracy level while increasing a precision of the spatial coordinate estimates above a first precision level. The method also includes determining time difference of arrival values based at least in part on applying weights to signals received from antennas of a subset of the plurality of phase-locked ARPs, the weights and phase-locked ARPs in the subset of phase-locked ARPs being determined to increase a precision of the spatial coordinate estimates above a second precision level higher than the first precision level. The method further includes estimating the spatial coordinates by applying timing error corrections to the time difference of arrival values, the applied timing error corrections being determined to increase accuracy of the spatial coordinate estimates above the second accuracy level, while maintaining the precision of the spatial coordinate estimates above the second precision level.

According to this aspect, in some embodiments, the applied timing error corrections are based at least in part on over-the-air timing measurements. In some embodiments, determining the time difference of arrival values includes: selecting one ARP in the subset of the plurality of phase-locked ARPs to be a reference ARP; and correlating a signal from the reference ARP with signals from other ARPs in the subset of the plurality of phase-locked ARPs. In some embodiments, the method includes prior to phase-locking the plurality of ARPs, obtaining a coarse phase alignment of the plurality of ARPs using a precision time protocol, PTP. In some embodiments, the method includes choosing ARPs to be in the subset of the plurality of phase-locked ARPs based at least in part on a level of multipath. In some embodiments, the method also includes choosing ARPs to be in the subset of the plurality of phase-locked ARPs based at least in part on reducing a covariance of the spatial coordinate estimates. In some embodiments, phase-locking the plurality of ARPs further comprises synchronizing the ARPs to a common clock reference to reduce non-common mode errors relative to common mode errors. In some embodiments, a number of phase-locked ARPs to be included in the subset of the plurality of phase-locked ARPs is a minimum number achievable subject to at least one constraint. In some embodiments, the applied timing error corrections are added to the time difference of arrival values. In some embodiments, the spatial coordinate estimates are determined relative to a ubiety location selected by a user of the WD 22.

According to another aspect, a network node 70 for estimating spatial coordinates of a WD 22 to achieve a relative positioning accuracy is provided. The network node 70 includes a synchronous clock 68, a plurality of antenna reference points, ARPs; and processing circuitry in communication with the synchronous clock 68 and the plurality of ARPs. The processing circuitry is configured to: phase-lock the plurality of ARPs using the synchronous clock 68, the phase-locking configured to allow an accuracy of spatial coordinate estimates to be reduced from a first accuracy level to a second accuracy level lower than the first accuracy level while increasing a precision of the spatial coordinate estimates above a first precision level, the ARPs being spatially distributed. The processing circuitry is further configured to determine time difference of arrival values based at least in part on applying weights to signals received from antennas of a subset of the plurality of phase-locked ARPs, the weights and phase-locked ARPs in the subset of the plurality of phase-locked ARPs being determined to increase a precision of the spatial coordinate estimates above a second precision level higher than the first precision level. The processing circuitry is also configured to estimate the spatial coordinates by applying timing error corrections to the time difference of arrival values, the applied timing error corrections being determined to increase accuracy of the spatial coordinate estimates above the second accuracy level, while maintaining the precision of the spatial coordinate estimates above the second precision level.

According to this aspect, in some embodiments, the applied timing error corrections are based at least in part on over-the-air timing measurements. In some embodiments, determining the time difference of arrival values includes: selecting one ARP in the subset of the plurality of phase-locked ARPs to be a reference ARP; and correlating a signal from the reference ARP with signals from other ARPs in the subset of the plurality of phase-locked ARPs. In some embodiments, the processing circuitry is further configured to, prior to phase-locking the plurality of ARPs, obtain a coarse phase alignment of the plurality of ARPs using a precision time protocol, PTP. In some embodiments, the processing circuitry is further configured to choose ARPs to be in the subset of the plurality of phase-locked ARPs based at least in part on a level of multipath. In some embodiments, the processing circuitry is further configured to choose ARPs to be in the subset of the plurality of phase-locked ARPs based at least in part on reducing a covariance of the spatial coordinate estimates. In some embodiments, phase-locking the plurality of ARPs further comprises synchronizing the plurality of ARPs to a common clock reference to reduce non-common mode errors relative to common mode errors. In some embodiments, a number of phase-locked ARPs to be included in the subset of the plurality of phase-locked ARPs is a minimum number achievable subject to at least one constraint. In some embodiments, the applied timing error corrections are added to the time difference of arrival values. In some embodiments, the spatial coordinate estimates are determined relative to a ubiety location selected by a user of the WD 22.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Some abbreviations that may be used herein are explained as follows:
3GPP 3rd Generation Partnership Project
4G Fourth Generation (LTE) Radio
5G Fifth Generation (NR) Radio
AECID Advanced Enhanced Cell Identifier
ARP Antenna Reference Point
BAW Bulk Acoustic Wave-a filter used in radios
BF Beamforming
CAPEX Capital Expenditures
COTS Commercial Off The Shelf
DL Downlink
Dot Digital remote radio used in Radio Dot System
DU Digital Unit
E911 Emergency 911 service for cell phone users.
eNB Enhanced Node B
GPS Global Positioning System
IEEE 1588 Institute of Electrical and Electronic Engineers, Standard #1588
IRU Indoor Radio Unit
KPI Key Performance Index
LTE Long Term Evolution (4th Generation Cellular)
LBT Listen Before Talk
LTE Long Term Evolution
NR Next Generation Radio
OPEX Operational Expenditures
OTDoA Observed Time Difference of Arrival
PLL Phase-Locked-Loop
PTP Precision Time Protocol (from IEEE 1588)
RDS Radio Dot System
RIBM Radio Interface Based Monitoring
RSRP Reference Signal Received Power
RSSI Received Signal Strength Indication
rTE Relative Time Error
RTT Round Trip Time
SAW Surface Acoustic Wave
SyncE Synchronous Ethernet
TDD Time Division Duplexing
ToA Time of Arrival
TDoA Time Difference of Arrival
Ubiety Identifier A UUID assigned to a marked location of interest
UE User Equipment, such as a cell phone
UL Uplink
UTDoA Uplink Time Difference of Arrival
UUID Universally Unique Identifier
UWB Ultra-Wide Band

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node for estimating spatial coordinates of a wireless device, WD, to achieve a relative positioning accuracy, the method comprising:
phase-locking a plurality of antenna reference points, ARPs, using a synchronous clock, the phase-locking configured to allow an accuracy of spatial coordinate estimates to be reduced from a first accuracy level to a second accuracy level while increasing a precision of the spatial coordinate estimates above a first precision level;
determining time difference of arrival values based at least in part on applying weights to signals received from antennas of a subset of the plurality of phase-locked ARPs, the weights and phase-locked ARPs in the subset of phase-locked ARPs being determined to increase a precision of the spatial coordinate estimates above a second precision level higher than the first precision level; and
estimating the spatial coordinates by applying timing error corrections to the time difference of arrival values, the applied timing error corrections being determined to increase accuracy of the spatial coordinate estimates above the second accuracy level, while maintaining the precision of the spatial coordinate estimates above the second precision level.

2. The method of claim 1, wherein the applied timing error corrections are based at least in part on over-the-air timing measurements.

3. The method of claim 1, wherein determining the time difference of arrival values includes:
selecting one ARP in the subset of the plurality of phase-locked ARPs to be a reference ARP; and
correlating a signal from the reference ARP with signals from other ARPs in the subset of the plurality of phase-locked ARPs.

4. The method of claim 3, further comprising, prior to phase-locking the plurality of ARPs, obtaining a coarse phase alignment of the plurality of ARPs using a precision time protocol, PTP.

5. The method of claim 1, further comprising choosing ARPs to be in the subset of the plurality of phase-locked ARPs based at least in part on a level of multipath.

6. The method of claim 1, further comprising choosing ARPs to be in the subset of the plurality of phase-locked ARPs based at least in part on reducing a covariance of the spatial coordinate estimates.

7. The method of claim 1, wherein phase-locking the plurality of ARPs further comprises synchronizing the ARPs to a common clock reference to reduce non-common mode errors relative to common mode errors.

8. The method of claim 1, wherein a number of phase-locked ARPs to be included in the subset of the plurality of phase-locked ARPs is a minimum number achievable subject to at least one constraint.

9. The method of claim 1, wherein the applied timing error corrections are added to the time difference of arrival values.

10. The method of claim 1, wherein the spatial coordinate estimates are determined relative to a ubiety location selected by a user of the WD.

11. A network node for estimating spatial coordinates of a wireless device, WD, to achieve a relative positioning accuracy, the network node comprising:
a synchronous clock;
a plurality of antenna reference points, ARPs; and
processing circuitry in communication with the synchronous clock and the plurality of ARPs, the processing circuitry configured to:
phase-lock the plurality of ARPs using the synchronous clock, the phase-locking configured to allow an accuracy of spatial coordinate estimates to be reduced from a first accuracy level to a second accuracy level lower than the first accuracy level while increasing a precision of the spatial coordinate estimates above a first precision level, the ARPs being spatially distributed;
determine time difference of arrival values based at least in part on applying weights to signals received from antennas of a subset of the plurality of phase-locked ARPs, the weights and phase-locked ARPs in the subset of the plurality of phase-locked ARPs being determined to increase a precision of the spatial coordinate estimates above a second precision level higher than the first precision level; and
estimate the spatial coordinates by applying timing error corrections to the time difference of arrival values, the applied timing error corrections being determined to increase accuracy of the spatial coordinate estimates above the second accuracy level, while maintaining the precision of the spatial coordinate estimates above the second precision level.

12. The network node of claim 11, wherein the applied timing error corrections are based at least in part on over-the-air timing measurements.

13. The network node of claim 11, wherein determining the time difference of arrival values includes:
selecting one ARP in the subset of the plurality of phase-locked ARPs to be a reference ARP; and
correlating a signal from the reference ARP with signals from other ARPs in the subset of the plurality of phase-locked ARPs.

14. The network node of claim 13, wherein the processing circuitry is further configured to, prior to phase-locking the plurality of ARPs, obtain a coarse phase alignment of the plurality of ARPs using a precision time protocol, PTP.

15. The network node of claim 11, wherein the processing circuitry is further configured to choose ARPs to be in the subset of the plurality of phase-locked ARPs based at least in part on a level of multipath.

16. The network node of claim 11, wherein the processing circuitry is further configured to choose ARPs to be in the subset of the plurality of phase-locked ARPs based at least in part on reducing a covariance of the spatial coordinate estimates.

17. The network node of claim 11, wherein phase-locking the plurality of ARPs further comprises synchronizing the plurality of ARPs to a common clock reference to reduce non-common mode errors relative to common mode errors.

18. The network node of claim 11, wherein a number of phase-locked ARPs to be included in the subset of the plurality of phase-locked ARPs is a minimum number achievable subject to at least one constraint.

19. The network node of claim 11, wherein the applied timing error corrections are added to the time difference of arrival values.

20. The network node of claim 11, wherein the spatial coordinate estimates are determined relative to a ubiety location selected by a user of the WD.
